(19) United States
(12) Patent Application Publication
(10) Pub. No.: US 2021/0322281 A1
(43) Pub. Date: Oct. 21, 2021

(54) PACIFIER COVER AND TEETHER

(71) Applicant: NUNI, Denver, CO (US)

(72) Inventor: Luke Haynie, Denver, CO (US)

(21) Appl. No.: 17/231,710

(22) Filed: Apr. 15, 2021

Related U.S. Application Data
(60) Provisional application No. 63/011,072, filed on Apr. 16, 2020.

(51) Int. Cl. A61J 17/00

(52) U.S. Cl. CPC A61J 17/109; A61J 17/113

(57) ABSTRACT

A pacifier cover system, a pacifier cover, a teether, and a pacifier cover and teether device capable of being attached to a pacifier are disclosed herein. The pacifier cover can attach to a pacifier handle to add a decorative flare to the pacifier, to increase the size of the pacifier such that the pacifier is easier to find when lost or when a child drops the pacifier, and to create a larger area to grip by both the parents and child. The pacifier cover can also include raised bumps or protrusions for teething and to assist in gripping the device. The pacifier cover includes a connecting mechanism having a connector ring with an outer sidewall connected to a back surface of the pacifier cover, an upper surface connected to the outer sidewall, an inner surface connected to the upper surface, and a curved portion with a radius of curvature interconnected to the inner surface and forming a lip. The connector ring further having a cavity formed by a cavity wall extending downward from the curved portion, the cavity at least partly surrounded by the connector ring, where the cavity receives a portion of the pacifier handle when the pacifier cover is connected to the pacifier.

### CROSS REFERENCE TO RELATED APPLICATIONS

This application claims the benefit of priority from U.S. Provisional Patent Application Ser. No. 63/011,072, filed Apr. 16, 2020, entitled “PACIFIER COVER AND TEETHER”; the entire disclosure of which is hereby expressly incorporated by reference in its entirety.

### FIELD OF THE INVENTION

Embodiments of the present invention generally relate to a pacifier cover system, a pacifier cover, and a teether, and more specifically to a pacifier cover and teether capable of being attached to a pacifier.

### BACKGROUND OF THE INVENTION

Pacifiers and teethers are known and have been used to soothe babies for centuries. Pacifier attachments and accessories are known, for example, clips and straps are commonly attached to pacifiers and children's clothing to prevent the pacifiers from falling on the ground or from getting lost. Small stuffed animals are also permanently attached to pacifiers to double as a toy and to make the pacifier easier for parents to find. Teethers come in all shapes and sizes, and can be made from a variety of materials such as rubber, plastic, silicone, or wooden teethers. Some teethers also utilize these same attachments and accessories used with pacifiers, while others are simply a teether.

### SUMMARY OF THE INVENTION

These and other needs are addressed by the various embodiments and configurations of the present invention. Embodiments of the present invention relate to a pacifier cover and teether device and a system comprising a pacifier cover and teether device and pacifier. The pacifier cover attaches to a pacifier handle to add a decorative flare to the pacifier, to increase the size of the pacifier such that the pacifier is easier to find when lost or when a child drops the pacifier, and to create a larger area to grip by either the parent or child. Some embodiments of the pacifier cover and teether device also includes raised bumps or protrusions for teething and to assist in gripping the device.

Embodiments of the pacifier cover and teether device can be attached to pacifiers or used on their own as teethers. Various embodiments have raised bumps or protuberances on which a child can chew to soothe sore gums while teething. Accordingly, the child can chew on the pacifier cover and teether when it is attached to the pacifier or when it is not attached to the pacifier.

It is one aspect of embodiments of the present invention to provide a safe teether and pacifier cover for infants and children. It is another aspect of embodiments of the present invention to provide a pacifier cover that can securely attach to a wide variety of different pacifiers. Thus, the pacifier cover can be used with most pacifiers already owned by the user. Part of the novelty of the pacifier cover and teether device is that it works with pacifiers of different shapes, sizes, materials, and brands.

Another aspect of embodiments of the present invention is to provide a pacifier cover and teether that is sanitary and easy to clean. For example, embodiments of the present invention are easier to clean than pacifier straps or stuffed animals attached to pacifiers. The pacifier cover and teether device can be handwashed with soap or other cleaners and it can be put in the dishwasher in some embodiments. Because the pacifier cover and teether device is composed of a solid, bendable material, for example, silicone, rubber, polymers, elastomers, or combinations thereof, it is easy to wipe clean and remove germs, unlike cloth pacifier straps or stuffed animals. The cover can also be sanitized in some embodiments.

In some embodiments, the pacifier cover and teether device has a connecting mechanism comprising a connector ring connected to the back surface at a radius of curvature. The connector ring has an outer sidewall that is substantially perpendicular to the back surface of the pacifier cover and an upper surface connected to the outer sidewall, where the upper surface is substantially perpendicular to the outer sidewall. The connector ring further has an inner surface connected to the upper surface, wherein the inner surface is substantially parallel to the outer sidewall. The connector ring, and specifically the upper surface, has an inner perimeter or edge proximate the inner surface and an outer perimeter or edge proximate the outer sidewall. In some embodiments, the connector ring also has a lip that extends around at least a portion of the connector ring (or all of the connector ring in some embodiments). In some embodiments, the lip only extends around a portion of the connector ring. The lip allows the pacifier cover to snap onto and stay on the pacifier handle.

Some embodiments include two or more notches, but other embodiments do not include the notch. In further embodiments, the notches are larger or smaller and/or have a different shape. In still further embodiments, the connecting mechanism includes additional notches. The notches assist in cleaning the cavity and connector ring. Moreover, the notches can accommodate pacifiers with rings interconnected to the pacifier handles.

In some embodiments, the handle of the pacifier fits into and connects to the connector ring. The connector ring of the pacifier cover can be sized and shaped to connect to the handle of the pacifier such that the pacifier handle head fits in the cavity of the connector. The upper surface of the connector ring can touch or be positioned adjacent to or in close proximity to the outer surface of the pacifier shield. The lip of the connector ring allows the pacifier cover to snap onto and stay on the pacifier handle. Thus, the underside or bottom of the lip can engage the underside or bottom of the pacifier handle head in some embodiments. Accordingly, the portion of the handle head with the largest diameter is held in the cavity and in the connector by the lip. Additionally, the inner surface of the connector ring is positioned adjacent to the handle stem of the pacifier handle and the handle head is positioned in the cavity of the connector when the pacifier is connected to the pacifier cover in various embodiments. The cavity is curved and sized and shaped to receive various pacifier handle head shapes.

Some embodiments of the present invention include a pacifier cover comprising: a decorative face on a front side; a back surface opposite the front side; and a connecting mechanism comprising: a connector ring comprising: an outer sidewall extending upwardly and away from the back surface; an upper surface interconnected to the outer sidewall at an outer perimeter; an inner surface interconnected to the upper surface at an inner perimeter; and a curved portion with a radius of curvature interconnected to the inner surface and forming a lip; and a cavity with a cavity wall extending downward from the curved portion, the cavity at least partly surrounded by the connector ring, wherein the lip extends inwardly from the connector ring and into the cavity. The pacifier cover according to some embodiments, further comprising a plurality of protrusions extending upwardly from the back surface and the connector ring comprises at least two notches extending downward from the upper surface. It is one aspect of the present invention to provide a method of manufacturing a pacifier cover as described herein.

According to one embodiment of the present invention, a pacifier and teether system is provided comprising: a pacifier; and a cover comprising: a decorative face on a front side; a back surface opposite the front side; and a connecting mechanism having a connector ring and a cavity, the connector ring comprising: an outer sidewall extending upwardly and away from the back surface; an upper surface interconnected to the outer sidewall at an outer perimeter; an inner surface interconnected to the upper surface at an inner perimeter; and a curved portion with a radius of curvature interconnected to the inner surface and forming a lip; wherein the cavity has a cavity wall extending downward from the curved portion, and wherein the cavity is at least partly surrounded by the connector ring, wherein the lip extends inwardly from the connector ring and into the cavity, and wherein a portion of the pacifier is positioned in the cavity such that the cover is detachably interconnected to the pacifier.

Some embodiments of the present invention include a pacifier cover comprising: a decorative design on a front side; a back surface opposite the front side; and a connecting mechanism comprising: a connector ring comprising: an outer sidewall extending upwardly and away from the back surface; an upper surface interconnected to the outer sidewall at an outer perimeter; an inner surface interconnected to the upper surface at an inner perimeter; and a curved portion with a radius of curvature interconnected to the inner surface; and a cavity with a cavity wall extending downward from the curved portion, the cavity at least partly surrounded by the connector ring, wherein the inner surface overhangs over the cavity and the inner surface together with the curved portion form a lip, and wherein the lip extends inwardly from the connector ring and into the cavity.

In various embodiment, the pacifier cover further comprises a plurality of protrusions extending upwardly from the back surface. In some embodiments, the connector ring comprises a first notch cut into the connector ring and extending downward from the upper surface of the connector ring. Additionally, the connector ring comprises a second notch cut into the connector ring and extending downward from the upper surface of the connector ring. Alternatively or additionally, the notch is formed by a first sidewall, a second sidewall, and a bottom surface positioned between and connected to the first and second sidewalls, wherein the notch has a height measured from the bottom surface to the upper surface of the connector ring and a width measured from the first sidewall to the second sidewall, and wherein the height is greater than the width. In some embodiments, a material of the pacifier cover is silicone, rubber, a polymer, an elastomer, or combinations thereof. In various embodiments, the outer sidewall of the connector ring is substantially smooth and is positioned substantially perpendicular to the back surface, wherein the upper surface of the connector ring is substantially smooth and is positioned substantially perpendicular to the outer sidewall, and wherein the inner surface of the connector ring is substantially smooth and is positioned substantially parallel to the outer sidewall. In some embodiments, the lip extends around the entire connector ring or the lip extends around the entire connector ring but does not extend into the first notch. In one embodiment, a method of manufacturing a pacifier cover according to claim 1 is provided.

In some embodiments of the present invention, a pacifier cover is provided comprising: a decorative design on a front side; a back surface opposite the front side; and a connecting mechanism comprising: a connector ring comprising: an outer sidewall extending upwardly from and substantially perpendicular to the back surface; an upper surface interconnected to the outer sidewall at an outer perimeter and positioned substantially perpendicular to the outer sidewall; an inner surface interconnected to the upper surface at an inner perimeter and positioned substantially parallel to the outer sidewall; and a curved portion with a first radius of curvature interconnected to the inner surface; and a cavity with a cavity wall extending downward from the curved portion, the cavity at least partly surrounded by the connector ring, and the cavity wall having a second radius of curvature; wherein the inner surface overhangs over the cavity and the inner surface together with the curved portion form a lip, wherein the lip extends inwardly from the connector ring and into the cavity, and wherein the pacifier cover is comprised of a bendable material.

In some embodiments, the bendable material is selected from the group comprising silicone, rubber, polymers, elastomers, or combinations thereof. In various embodiments, the connector ring comprises a first notch cut into the connector ring and extending downward from the upper surface of the connector ring, wherein the notch is formed by a first sidewall, a second sidewall, and a bottom surface positioned between and connected to the first and second sidewalls. In some embodiments, the lip extends around the entire connector ring.

In some embodiments of the present invention, a pacifier and teether system is provided comprising: a pacifier having a nipple and a handle; and a cover comprising: a decorative design on a front side; a back surface opposite the front side; and a connecting mechanism having a connector ring and a cavity, the connector ring comprising: an outer sidewall extending upwardly and away from the back surface; an upper surface connected to the outer sidewall at an outer perimeter; an inner surface connected to the upper surface at an inner perimeter; and a curved portion with a radius of curvature interconnected to the inner surface and forming a lip; wherein the cavity has a cavity wall extending downward from the curved portion, and wherein the cavity is at least partly surrounded by the connector ring, wherein the lip extends inwardly from the connector ring and into the cavity, and wherein a portion of the pacifier handle is positioned in the cavity such that the cover is detachably connected to the pacifier.

In various embodiments, the cover further comprises a plurality of protrusions extending upwardly from the back surface. In some embodiments, the connector ring comprises a first notch cut into the connector ring and extending downward from the upper surface of the connector ring, and wherein the notch is formed by a first sidewall, a second sidewall, and a bottom surface positioned between and connected to the first and second sidewalls. In additional or alternative embodiments, the outer sidewall of the connector ring is positioned substantially perpendicular to back surface, wherein the upper surface of the connector ring is positioned substantially perpendicular to the outer sidewall, and wherein the inner surface of the connector ring is positioned substantially parallel to the outer sidewall, and wherein the pacifier handle comprises a substantially cylindrical stem portion connected to a head portion having a diameter at a portion proximate the stem portion that is larger than a diameter of the stem portion. In some embodiments, the head portion of the pacifier handle is positioned in the cavity of the cover connector ring and the inner surface of the cover connector ring is positioned adjacent the pacifier stem portion when the pacifier is connected to the cover. In various embodiments, the cover is made of silicone, rubber, a polymer, an elastomer, or combinations thereof.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1 shows one embodiment of the pacifier cover and teether device being used by a child;

FIG. 2 is a front elevation view of an embodiment of a pacifier and teether device having a monkey face;

FIG. 3 is a front elevation view of an embodiment of a pacifier and teether device having a panda face;

FIG. 4 is a front elevation view of an embodiment of a pacifier and teether device having a hedgehog face;

FIG. 5 is a front elevation view of an embodiment of a pacifier and teether device having an elephant face;

FIG. 6 is a front view of a pacifier cover and teether device according to one embodiment and a pacifier;

FIG. 7 is a rear elevation view of the pacifier cover and teether device;

FIG. 8 is a rear elevation view of a pacifier cover and teether device according to one embodiment;

FIG. 9 is a rear elevation view of a pacifier cover and teether device according to one embodiment;

FIG. 10 is a rear elevation view of a pacifier cover and teether device according to one embodiment;

FIG. 11 is a rear elevation view of a pacifier cover and teether device according to one embodiment;

FIG. 12 is a perspective view of a pacifier cover and teether device according to one embodiment and a pacifier before being connected to one another;

FIG. 13 is another perspective view of the pacifier cover and teether device and pacifier before being connected to one another;

FIG. 14 is a perspective rear view of a pacifier cover and teether device according to one embodiment;

FIG. 15A is a cross-sectional view of the pacifier cover and teether device taken along the line 15-15 in FIG. 8;

FIG. 15B is a perspective view of the section 15-15;

FIG. 16 is a cross-sectional view of the pacifier cover and teether device taken along line 16-16 in FIG. 8;

FIG. 17 is a rear side perspective view of the pacifier cover and teether device according to one embodiment connected to a pacifier;

FIG. 18 is a side elevation view of the pacifier cover and teether device according to one embodiment connected to a pacifier; and

FIG. 19 is a top plan view of the pacifier cover and teether device according to one embodiment connected to a pacifier.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

Note that sometimes the pacifier cover and teether device is referred to as a pacifier cover, other times it is referred to as a teether, and still other times it is referred to as both a pacifier cover and teether or pacifier cover and teether device. Any pacifier cover described herein in connection with the present invention could be used as a teether and vice versa. Thus, no limitations are implied by using the term “pacifier cover” or “teether” alone. Rather, the device can be referred to as merely a “pacifier cover” or “teether” alone to reduce wordiness.

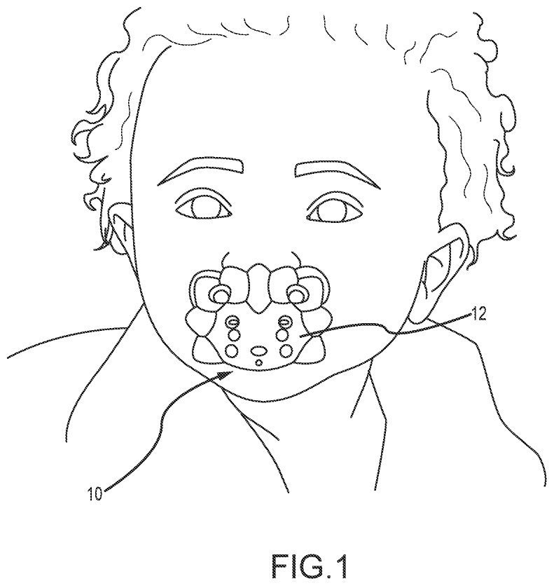

FIG. 1 shows one embodiment of the pacifier cover and teether device 10 interconnected to a pacifier (not visible in this view) being used by a child. The front 12 of the pacifier cover 10 is seen in this view. FIG. 1 shows the general size of the pacifier cover 10. However, in other embodiments, the pacifier cover 10 can be larger or smaller than shown in FIG. 1.

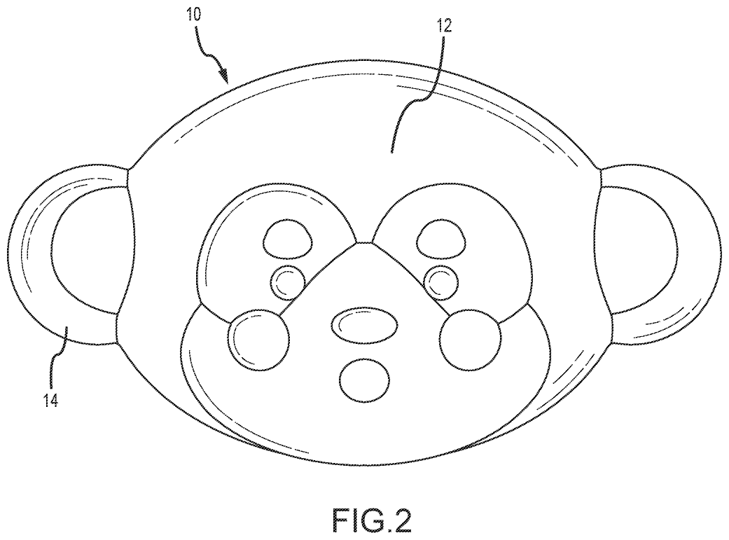

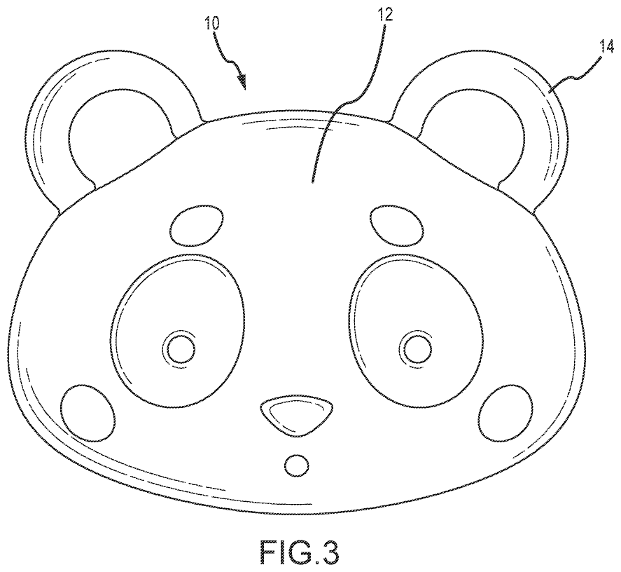

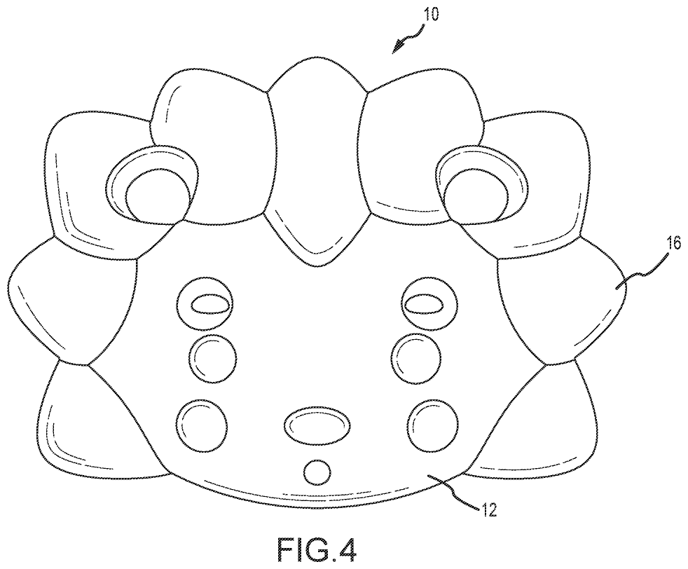

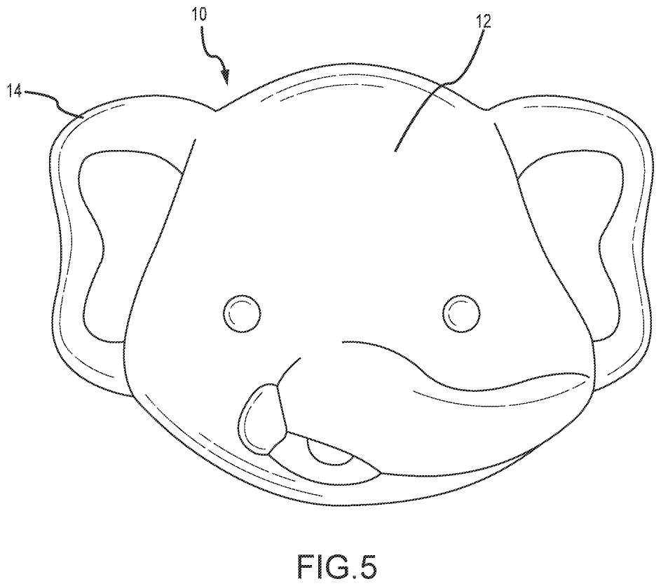

FIGS. 2-5 are front elevation views of various embodiments of a pacifier cover and teether device 10. The front 12 is a face in some embodiments. The front 12 of the pacifier cover 10 has a monkey face in FIG. 2, a panda face in FIG. 3, a hedgehog face in FIG. 4, and an elephant face in FIG. 5. These different cover faces are provided as illustrations of potential cover faces, but one skilled in the art would understand that other faces, animals, or characters can be used without deviating from the invention. The front side 12 of the pacifier cover faces away from the pacifier, away from the user, and out toward others, for example, the parents of the child with the pacifier. The ears 14 can extend outwardly from the face to provide a portion for the child or care giver to hold. In the hedgehog embodiment (FIG. 4), the spines 16 extend outwardly from the face to provide a portion for the child or care giver to hold.

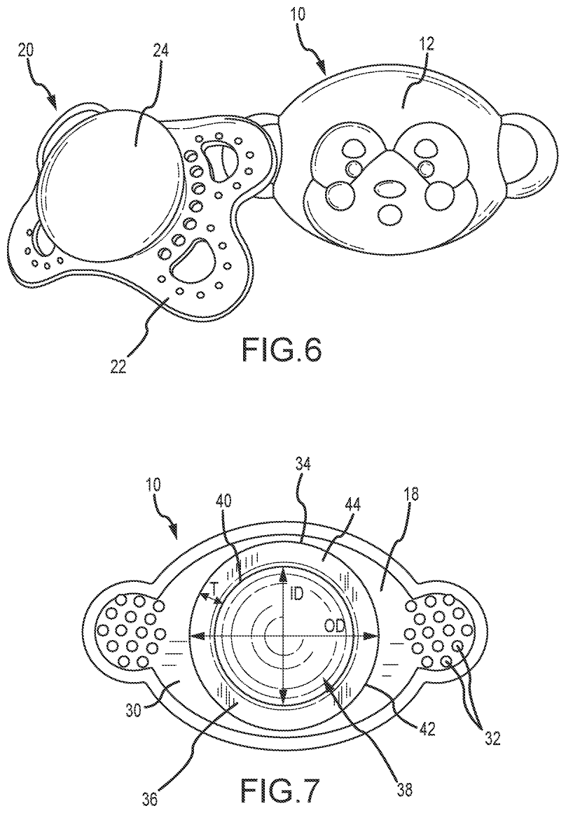

FIG. 6 is a front view of a pacifier cover 10 according to one embodiment and a pacifier 20 according to one embodiment. Here, the pacifier cover 10 is detached from the pacifier 20. The pacifier 20 has a shield or guard 22 (terms used interchangeably herein) and a handle or knob 24 (terms used interchangeably herein). As shown in other figures, the pacifier cover 10 attaches to the pacifier 20 via the handle 24. As shown in other figures, the pacifier cover 10 can be sized such that it is larger than the pacifier shield 22, meaning that the pacifier shield 22 cannot be seen from a front view when the pacifier cover 10 is attached to the pacifier 20.

FIG. 7 is a rear view of the pacifier cover and teether 10. The back side 18 of the pacifier cover 10 has a back surface or rear surface 30 (terms used interchangeably), teething bumps or protuberances 32 (terms used interchangeably), and a connector or connecting mechanism 34 (terms used interchangeably). In some embodiments, the teether 10 has additional teething bumps positioned on the back side 18 and/or front side 12 of the teether 10. The connecting mechanism 34 interconnects the pacifier 20 to the pacifier cover 10. The connector 34 comprises a ring or connector ring 36 (terms used interchangeably herein) and a cavity 38 positioned within and partly formed by the connector ring 36. The upper portion of the connector ring 36 has an inner perimeter (edge) 40 and an outer perimeter (edge) 42. The connector ring 36 can have various dimensions.

In one embodiment, the outer diameter OD of the connector ring 36 as measured from the outer perimeter (edge) 42 of the upper surface 44 is between about 1.0 inch and 1.5 inch, in some embodiments about 1.0 inch, about 1.1 inch, about 1.15 inch, about 1.2 inch, about 1.25 inch, about 1.3 inch, about 1.35 inch, about 1.4 inch, about 1.45 inch, or about 1.5 inch, or a range or value between two of these values. In a preferred embodiment, the outer diameter OD is between about 1.2 inch and 1.3 inch. In a more preferred embodiment, the outer diameter OD is about 1.25 inch. In one embodiment, the inner diameter ID of the connector ring 36 as measured from the inner perimeter (edge) 40 of the upper surface 44 is between about 0.75 inch and 1.25 inch, in some embodiments about 0.75 inch, about 0.8 inch, about 0.85 inch, about 0.9 inch, about 0.95 inch, about 1.0 inch, about 1.05 inch, about 1.1 inch, about 1.15 inch, about 1.2 inch, or about 1.25, or a range or value between two of these values. In a preferred embodiment, the inner diameter ID of the inner perimeter (edge) 40 is between about 0.90 inch and 1.05 inch. In a more preferred embodiment, the inner diameter ID of the inner perimeter (edge) 40 is about 0.9375 ( 15/16) inch. In another more preferred embodiment, the inner diameter ID of the inner perimeter (edge) 40 is about 1.0 inch. In one embodiment, the thickness T of the upper portion (measured on the upper surface 44) of the connector ring 36 is between about 0.05 inch and 0.20 inch, in some embodiments about 0.05 inch, about 0.1 inch, about 0.15 inch, or about 0.2 inch, or a range or value between two of these values. In a preferred embodiment, the thickness T of the upper portion of the connector ring 36 is between about 0.10 inch and 0.15 inch. In a more preferred embodiment, the thickness T of the upper portion of the connector ring 36 is about 0.125 (⅛) inch.

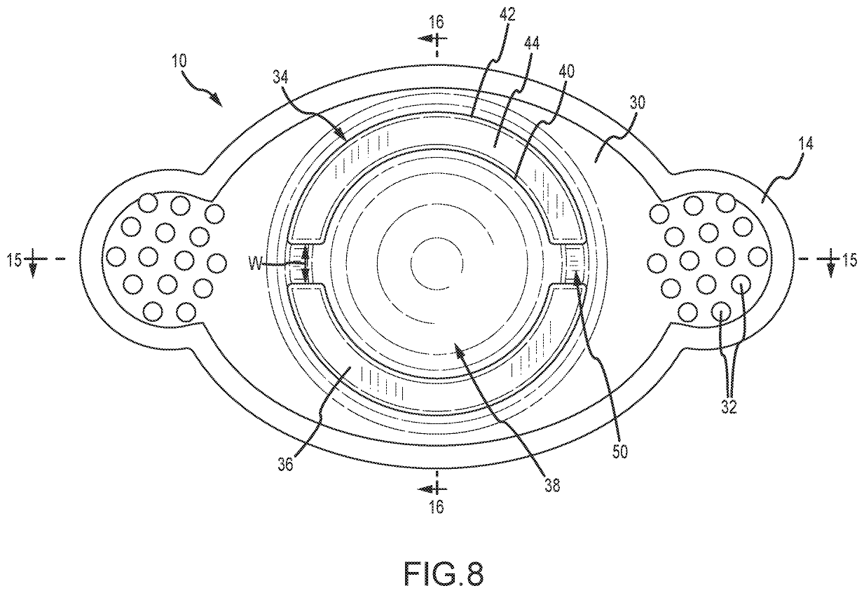

FIG. 8 is a rear view of a pacifier cover and teether 10 according to one embodiment. Here, the connector ring 36 has two notches 50. The connector ring could have one notch 50 or more than two notches 50 in other embodiments. The notches 50 can have various shapes (V-shaped, curved, rectangular, etc.) and could be larger (up to about 90% of the ring) or smaller (0% of the connector ring, i.e. a closed ring as depicted in FIG. 7) than shown. In some embodiments, the notches can be about 0% of the connector ring, about 5% of the connector ring, about 10% of the connector ring, about 15% of the connector ring, about 20% of the connector ring, about 25% of the connector ring, about 30% of the connector ring, about 35% of the connector ring, about 40% of the connector ring, about 45% of the connector ring, about 50% of the connector ring, about 55% of the connector ring, about 60% of the connector ring, about 65% of the connector ring, about 70% of the connector ring, about 75% of the connector ring, about 80% of the connector ring, or about 90% of the connector ring, or in some embodiments a range between two of these values. The notches 50 have a width W. In some embodiments, the width W of the notch 50 is between about 0.10 inch and 0.40 inch, in some embodiments about 0.1 inch, about 0.15 inch, about 0.2 inch, about 0.25 inch, about 0.3 inch, about 0.35 inch, or about 0.4 inch, or a range or value between any two of these values. In a preferred embodiment, the width W of the notch 50 is between about 0.125 inch and 0.30 inch. In a more preferred embodiment, the notch 50 has a width W between about 0.15 inch and about 0.25 inch. In a more preferred embodiment, the width W of the notch 50 is about 0.20 inch or about 5 mm. The width W can be larger than 0.40 inch in some embodiments.

The notches 50 assist in cleaning the cavity 38 and connector ring 36. Moreover, the notches 50 can accommodate pacifiers 20 with rings interconnected to the pacifier handles. The notches 50 can also be positioned in different locations, for example the top and bottom of the ring connector 36 (i.e., 90 degrees from where they are shown), the sides of the ring connector 36 (as shown in FIG. 8), or at an angle somewhere between the top, bottom, and sides (i.e., between 5 degrees and 85 degrees from where they are shown in FIG. 8). This pacifier cover and teether 10 also has teething bumps or protuberances 32 on the ears 14. The back surface 30 is smooth, but could be bumpy for additional teething options.

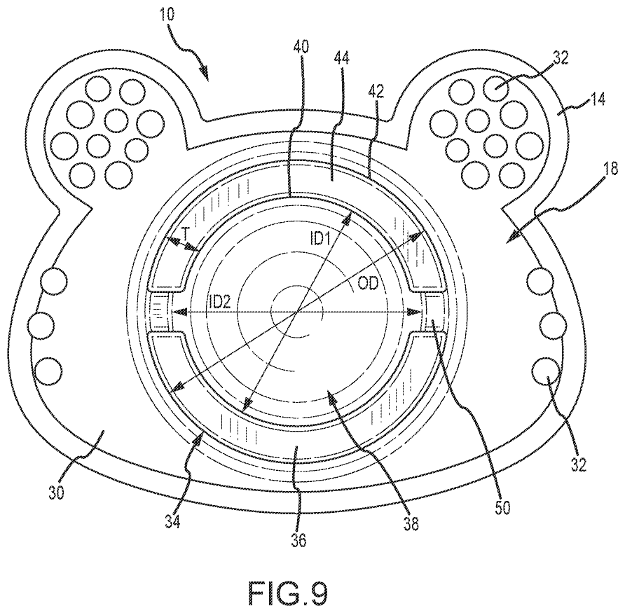

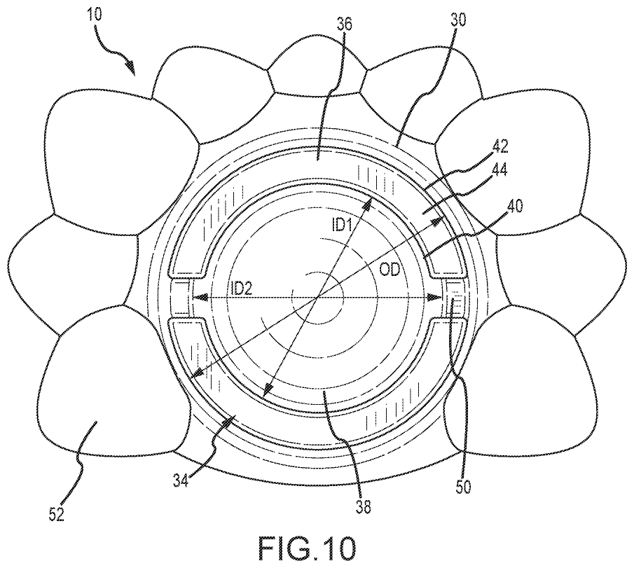

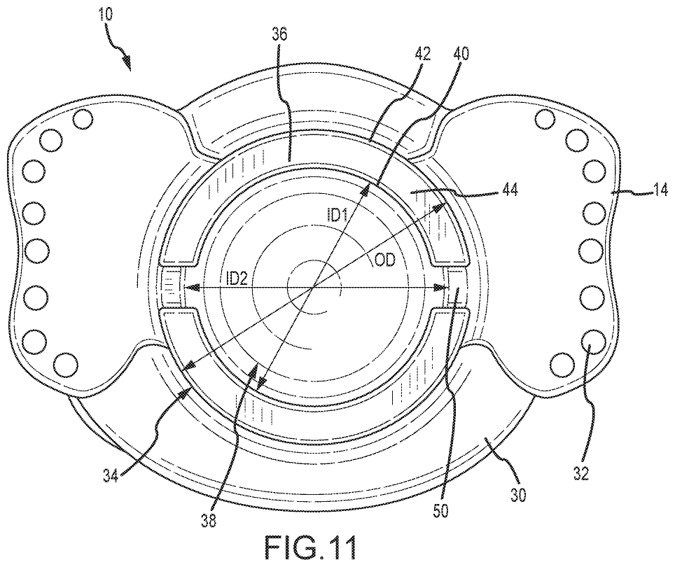

FIGS. 9-11 are rear views of various embodiments of pacifier covers and teethers 10. FIG. 10 does not have teething bumps 32 similar to those shown in FIGS. 8, 9, and 11, but these bumps could be added. Some teething bumps 32 are shown on the ears 14 of the teethers 10 while other teething bumps 32 are shown elsewhere on the back surface 30. Moreover, FIG. 10 shows alternative teething portions 52 that are larger than the teething bumps shown in FIGS. 8-9 and 11. The size and shape of the bumps 32 can be varied without deviating from the invention, and can be uniformly oriented on the pacifier cover 10, or randomly oriented without deviating from the invention. The bumps 32 can also be positioned on the face 12 of the pacifier cover and teether device 10. FIG. 8 is the rear view of a monkey pacifier cover, FIG. 9 is the rear view of a panda pacifier cover, FIG. 10 is the rear view of a hedgehog pacifier cover, and FIG. 11 is the rear view of an elephant pacifier cover.

In one embodiment, the outer diameter OD of the connector ring 36 as measured from the outer perimeter (edge) 42 of the upper surface 44 is between about 1.0 inch and 1.5 inch, in some embodiments about 1.0 inch, about 1.05 inch, about 1.1 inch, about 1.15 inch, about 1.2 inch, about 1.25 inch, about 1.3 inch, about 1.35 inch, about 1.4 inch, about 1.45 inch, about 1.5 inch, or a range or value between any of two of these values. In a preferred embodiment, the outer diameter OD is between about 1.2 inch and 1.3 inch. In a more preferred embodiment, the outer diameter OD is about 1.25 inch. In one embodiment, the inner diameter ID1 of the connector ring 36 as measured from the inner perimeter (edge) 40 of the upper surface 44 is between about 0.75 inch and 1.25 inch. In a preferred embodiment, the inner diameter ID1 of the inner perimeter (edge) 40 is between about 0.90 inch and 1.05 inch, in some embodiments about 0.90 inch, about 0.95 inch, about 1.0 inch, about 1.05 inch, or a range or value between any two of these values. In a more preferred embodiment, the inner diameter ID1 of the inner perimeter (edge) 40 is about 0.9375 ( 15/16) inch. In another more preferred embodiment, the inner diameter ID1 of the inner perimeter (edge) 40 is about 1.0 inch. In one embodiment, the inner diameter ID2 of the connector ring 36 as measured at the notches 50 is between about 0.65 inch and 1.15 inch, in some embodiments about 0.65 inch, about 0.7 inch, about 0.75 inch, about 0.8 inch, about 0.85 inch, about 0.9 inch, about 0.95 inch, about 1.0 inch, about 1.05 inch, about 1.1 inch, about 1.15 inch, or any value or range between any two of these values. In a preferred embodiment, the inner diameter ID2 of the connector ring 36 as measured at the notches 50 is between about 0.80 inch and 0.95 inch. In a more preferred embodiment, the inner diameter ID2 of the connector ring 36 as measured at the notches 50 is about 0.9 inch. In another more preferred embodiment, the inner diameter ID2 of the connector ring 36 as measured at the notches 50 is about 0.825 inch. In one embodiment, the thickness T of the upper portion (measured on the upper surface 44) of the connector ring 36 is between about 0.05 inch and 0.20 inch, in some embodiments about 0.05 inch, about 0.1 inch, about 0.15 inch, about 0.2 inch, or a value or range between any two of these values. In a preferred embodiment, the thickness T of the upper portion of the connector ring 36 is between about 0.10 inch and 0.15 inch. In a more preferred embodiment, the thickness T of the upper portion of the connector ring 36 is about 0.125 (⅛) inch.

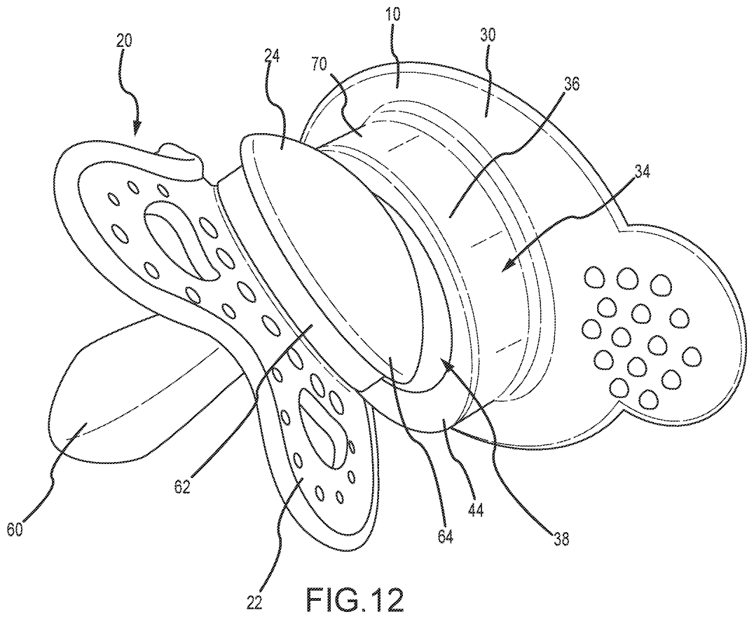

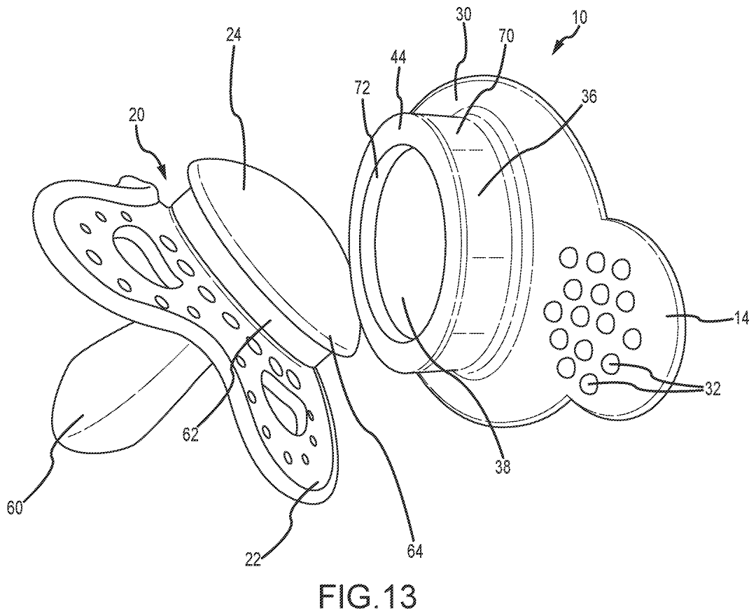

FIGS. 12 and 13 show the pacifier 20 and pacifier cover 10 before being interconnected to one another. The pacifier 20 comprises a nipple 60, shield 22, and handle 24. The handle 24 has a handle stem 62 and a handle head 64. The handle stem 62 is substantially cylindrical and the handle head 64 has a larger diameter than the stem 62 at the portion proximate the stem 62. The handle head 64 has somewhat of a mushroom cap shape and together with the stem 62, the handle 24 has a mushroom (cap and stem) shape. This is typical of pacifiers 20 and nothing about the pacifier 20 described herein is alleged to be novel or new. The connector ring 36 of the pacifier cover 10 is sized and shaped to connect to the handle 24 of the pacifier 20 such that the pacifier handle head 64 fits in the cavity 38 of the connector 34. The upper surface 44 of the connector ring 36 can touch or be positioned adjacent to or in close proximity to the outer surface of the pacifier shield 22. As can be seen here, and is described in more detail below, the connector 34 has a sidewall (also called an outer sidewall) 70 extending outwardly from the rear surface 30 and forming the outer boundary of the connector ring 36.

FIG. 13 shows more of the shape of the connector 34 and connector ring 36. The connector ring 36 has a substantially smooth outer sidewall 70 positioned substantially perpendicular to the back surface 30, a substantially smooth and/or flat upper surface 44 connected to the outer sidewall 70 and positioned substantially perpendicular to the outer sidewall 70, and a substantially smooth inner surface 72 connected to the upper surface and substantially parallel to the outer sidewall 70. The outer sidewall 70, upper surface 44, and/or inner surface 72 may not be smooth in some embodiments. Moreover, the outer sidewall 70, upper surface 44, and/or inner surface 72 may be positioned at different angles than those shown in FIG. 13. The upper surface 44 extends slightly into the cavity 38 such that the inner surface 72 overhangs over the cavity 38, thus forming a lip portion (discussed in more detail below).

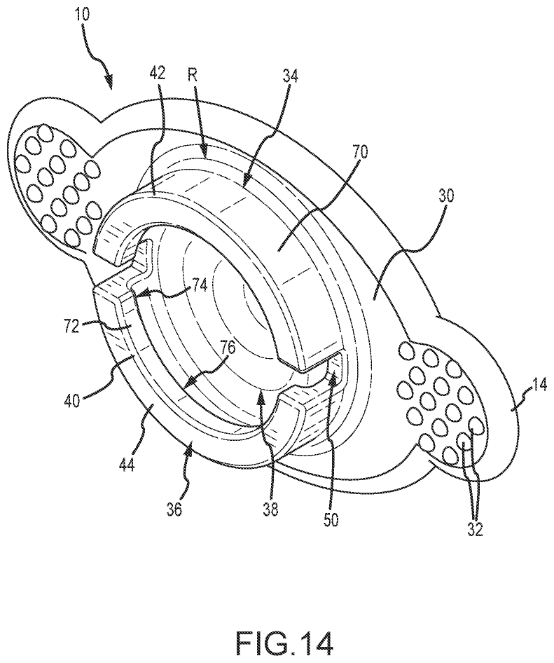

FIG. 14 is a perspective rear view of the pacifier cover 10 according to some embodiments. The connector 34 comprises a connector ring 36 extending upwardly from and substantially perpendicular to the back surface 30. The connector ring 36 can be connected to the back surface 30 at a radius of curvature R. The connector ring 36 has a substantially smooth outer sidewall 70 positioned substantially perpendicular to the back surface 30, a substantially smooth and/or flat upper surface 44 connected to the outer sidewall 70 and positioned substantially perpendicular to the outer sidewall 70, and a substantially smooth inner surface 72 connected to the upper surface 44 and substantially parallel to the outer sidewall 70. The outer sidewall 70, upper surface 44, and/or inner surface 72 may not be smooth in some embodiments. Moreover, the outer sidewall 70, upper surface 44, and/or inner surface 72 may be positioned at different angles than those shown in FIG. 14. The upper surface 44 extends slightly into the cavity 38 such that the inner surface 72 overhangs over the cavity 38, thus forming a lip portion 74. The lip 74 extends around the entire connector ring 36, except for the notches 50 if notches 50 are present in the specific embodiment. The embodiment shown in FIG. 13 (i.e., a connector ring 36 without notches 50) also has a lip 74 that extends around at least a portion of the connector ring 36 (or all of the connector ring 36 in some embodiments). In some embodiments, the lip 74 only extends around a portion of the connector ring 36. The lip 74 allows the pacifier cover 10 to snap onto and stay on the pacifier handle 24. Thus, the underside or bottom 76 of the lip 74 engages the underside or bottom of the pacifier handle head 64. Accordingly, the portion of the handle head 64 with the largest diameter is held in the cavity 38 and in the connector 34 by the lip 74. Additionally, the inner surface 72 of the connector ring 36 is positioned adjacent to the handle stem 62 of the pacifier handle 24 and the handle head 64 is positioned in the cavity 38 of the connector 34 when the pacifier 20 is connected to the pacifier cover 10. The cavity 38 is curved and sized and shaped to receive various pacifier handle head 64 shapes. For example, the cavity 38 may be dome shaped and have a constant radius of curvature. Alternatively, the radius of curvature of the cavity 38 can vary throughout the cavity 38. Part of the novelty of the pacifier cover and teether device 10 is that it works with pacifiers of different shapes, sizes, and brands. This is true for all embodiments of the pacifier cover 10 described herein.

The pacifier cover and teether 10 is made of a bendable material, for example, silicone, rubber, polymers, elastomers, or combinations thereof. In various embodiments, the entire pacifier cover 10 is made of the same material. Therefore, the connector 34 is also a bendable material, which permits the user to snap the pacifier handle 24 into the connector 34 and to pull the pacifier handle 24 out of the connector 34.

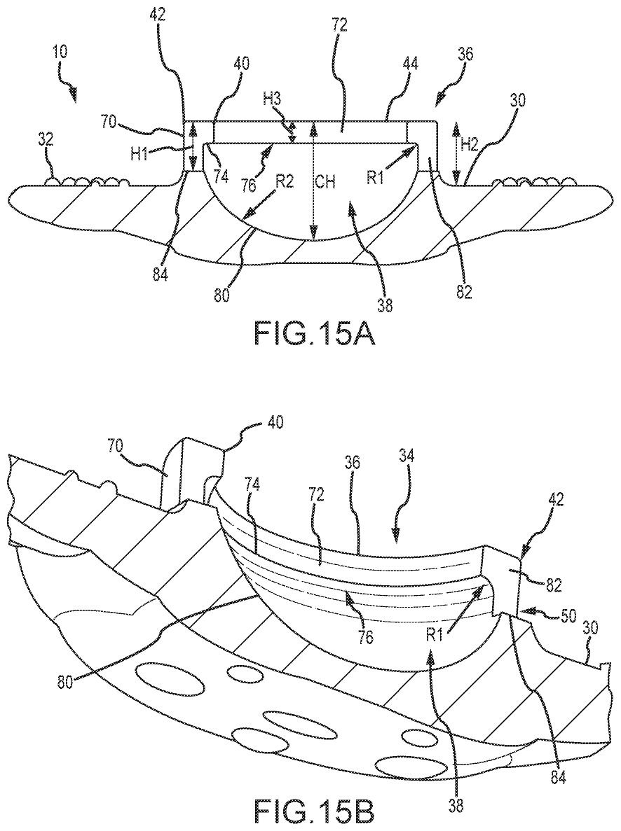

FIG. 15A is a cross-sectional view of the pacifier cover 10 taken along the line 15-15 in FIG. 8. Thus, the cross-section is cut through both notches 50. From this view, the lip 74 formed by the radius of curvature R1 and positioned under the inner surface 72 can be seen, along with the shape of the cavity 38. Thus, the lip 74 and inner surface 72 extend out into the cavity 38 to securely hold the pacifier. The underside or bottom 76 of the lip 74 extends from the inner surface 72 to the radius of curvature R1 and then to the cavity wall 80.

The notch sidewall 82 and the notch bottom surface 84 can also be seen in this view. The notch sidewall 82 is substantially flat and positioned substantially vertically in this view, i.e., substantially perpendicular to the upper surface 44 of the connector ring 36 and the back surface 30. The notch bottom surface 84 is substantially flat and positioned substantially parallel to the back surface 30 and upper surface 44 of the connector ring 36. The height H1 of the cutout 50 is shown and is measured from the notch bottom surface 84 to the upper surface 44 of the connector ring 36. The heigh H1 of the cutout 50 is the same as the height of the linear portion of the connector ring outer sidewall 70 in this embodiment. In some embodiments, the notch has a height H1 between about 0.15 inch and about 0.50 inch, in some embodiments about 0.15 inch, about 0.2 inch, about 0.25 inch, about 0.3 inch, about 0.35 inch, about 0.4 inch, about 0.45 inch, about 0.5 inch, or a value or range between any two of these values. In a preferred embodiment, the notch has a height H1 between about 0.20 inch and about 0.4 inch. In a more preferred embodiment, the notch has a height H1 between about 0.20 inch and about 0.3 inch.

The height from the back surface 30 to the upper surface 44 is labeled H2. H2 is greater than H1 because it included the curved bottom portion of the outer sidewall 70. In some embodiments, the height H2 is between about 0.20 inch and about 0.50 inch, in some embodiments between 0.2 inch, about 0.25 inch, about 0.3 inch, about 0.35 inch, about 0.4 inch, about 0.45 inch, about 0.5 inch, or a value or range between any two of these values. In a preferred embodiment, the height H2 is between about 0.25 inch and about 0.40 inch. In a more preferred embodiment, the height H2 is between about 0.25 inch and about 0.35 inch.

The cavity 38 has a depth or height CH as measured from the upper surface 44 to the lowest point of the cavity 38. In some embodiments, the cavity height CH is between about 0.40 inch and about 0.80 inch, in some embodiments about 0.4 inch, about 0.45 inch, about 0.5 inch, about 0.55 inch, about 0.6 inch, about 0.65 inch, about 0.7 inch, about 0.75 inch, about 0.8 inch, or a value or range between any two of these values. In a preferred embodiment, the cavity height CH is between about 0.50 inch and about 0.70 inch. In a more preferred embodiment, the cavity height CH is between about 0.55 inch and about 0.65 inch.

The inner surface 72 has a height H3, which is also the distance the lip 74 is positioned below the upper surface 44 of the connector ring 36. In some embodiments, the height H3 is between about 0.05 inch and about 0.15 inch, in some embodiments about 0.05 inch, about 0.1 inch, about 0.15 inch, or a value or range between any two of these values. In a preferred embodiment, the height H3 is between about 0.07 inch and about 0.13 inch. In a more preferred embodiment, the height H3 is between about 0.08 inch and about 0.12 inch.

FIG. 15B is a perspective view of section 15-15 of the pacifier cover 10. From this view, the notch sidewall 82, flat inner surface 72, lip 74, underside or bottom 76 of the lip 74, and radius of curvature R1 are clearly seen. The inner surface 72 of the connector ring 36 extends out and over the cavity 38 and the underside 76 extends inward toward the cavity wall 80 to form the lip 74.

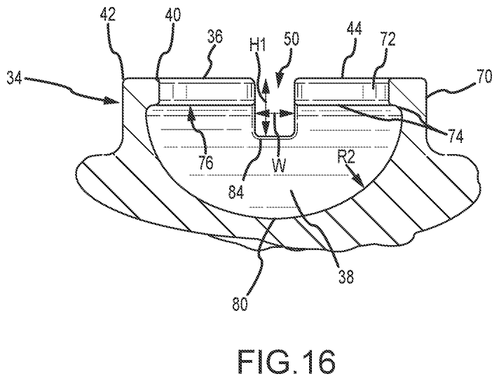

FIG. 16 is a cross-sectional view of the pacifier cover 10 taken along line 16-16 in FIG. 8. The shape of the notch 50 is easily seen in this view. Although the notch 50 is shown as rectangular shaped, with a height H1 larger than its width W, the notch 50 could be wider or shorter. In other embodiments, the notch 50 is narrower or taller than shown in FIG. 16. The preferred width W of the notch 50 are provided above in connection with FIG. 8 and will not be repeated, but are expressly included with this embodiment. The notches 50 can have various shapes (V-shaped, curved, rectangular, etc.) and could be larger (up to about 90% of the ring) or smaller (0% of the connector ring, i.e. a closed ring as depicted in FIG. 7) than shown. In some embodiments, the notch 50 has a height H1 between about 0.15 inch and about 0.50 inch. In a preferred embodiment, the notch 50 has a height H1 between about 0.20 inch and about 0.4 inch. In a more preferred embodiment, the notch 50 has a height H1 between about 0.20 inch and about 0.3 inch.

In still further embodiments, the notch 50 is angled such that the width W of the notch 50 increases along the height H1. For example, the top of the notch 50 is wider than the bottom of the notch 50. Still further, the bottom surface 84 of the notch 50 could be curved, rounded, or angled instead of substantially flat or linear as shown here. Additionally, because the connecting mechanism 34 has a circular shape, the radius of curvature R2 of the bottom surface 80 of the cavity 38 is approximately the same in the direction shown in FIG. 16 as it is in FIG. 15A. However, in some embodiments, the radius of curvature R2 in one direction (for example, as shown in FIG. 15A) could be different than the radius of curvature R2 in the other direction (for example, as shown in FIG. 16). Moreover, in other embodiments, the connecting mechanism 34 may have an oval shape such that the radius of curvature R2 in one direction (for example, as shown in FIG. 15A) is different than the radius of curvature R2 in the other direction (for example, as shown in FIG. 16).

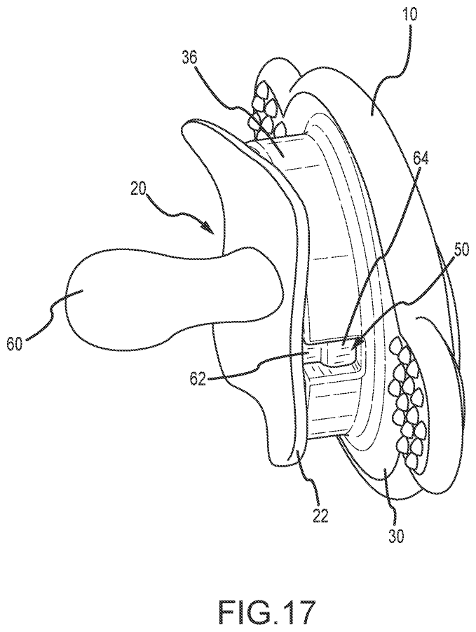

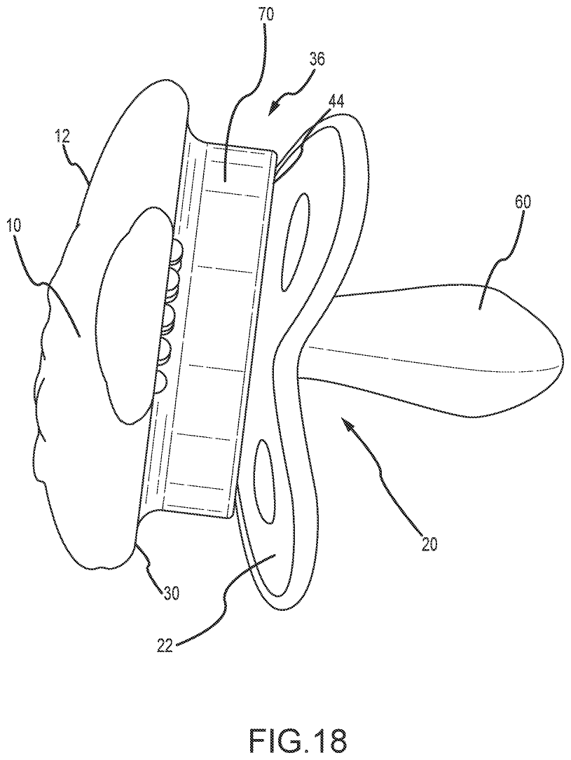

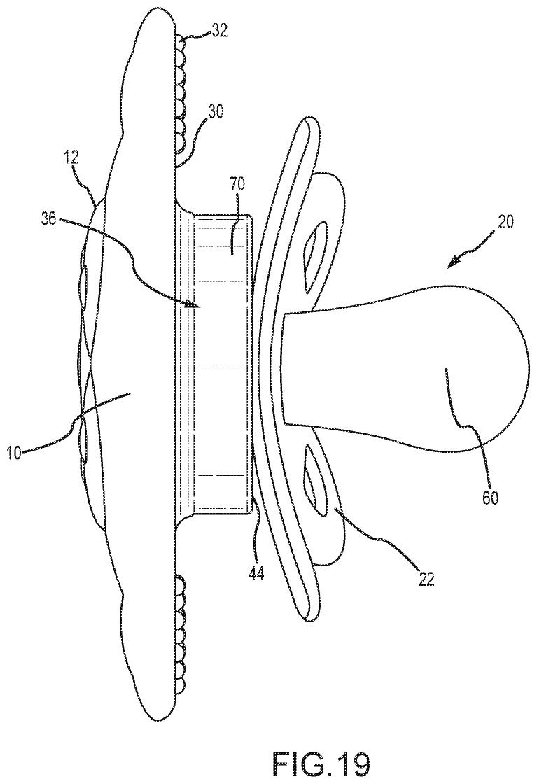

FIGS. 17, 18, and 19 show the pacifier cover 10 interconnected to the pacifier 20. FIG. 17 is a rear side perspective view. FIG. 18 is a side elevation view. FIG. 19 is a top plan view. As is seen from these figures, the pacifier cover 10 attaches to and surrounds the handle or knob 24 of the pacifier 20. Thus, only the nipple 60 and shield 22 of the pacifier 10 are visible, except that the stem 62 and head 64 of the handle 24 can be seen through the notch 50 in FIG. 17. If the pacifier handle 24 had a ring, then the ring would also be visible because it would protrude out of the notches 50 and sit above or below the connector ring 36. The pacifier cover 10 is sized and shaped to surround and cover the pacifier handle or knob 24. In some embodiments, the connector ring 36 only partially covers the pacifier handle 24 without deviating from the invention.

The pacifier cover 10 in FIG. 18 does not include the notches 50, but an embodiment with notches 50 is within the scope of the invention and specifically within the scope of FIGS. 17-19. The top and side views show how the pacifier cover 10 connects to the pacifier 20. Specifically, a portion of the shield 22 of the pacifier 20 touches a portion of the upper surface 44 of the connector ring 36. The outer sidewall 70 in conjunction with the cavity 38 encloses some or all of the pacifier handle 24.

The pacifier cover can be any desired material, but is preferably a bendable material such as silicone, polymer, elastomer, or rubber. Because the pacifier cover can also function as a teether, the pacifier cover should be made of a medical grade and/or food grade silicone, polymer, elastomer, or combinations thereof. In various embodiments, the pacifier cover is dishwasher safe, can be washed with soap and water, and can be sanitized.

Methods of making the pacifier cover and teether include molding, injection molding, and additive manufacturing (e.g., 3D printing).

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

Additionally, various features/components of one embodiment may be combined with features/components of another embodiment. For example, features/components of one figure can be combined with features/components of another figure or features/components of multiple figures. To avoid repetition, every different combination of features has not been described herein, but the different combinations are within the scope of this disclosure. Additionally, if details (including angles, dimensions, etc.) about a feature or component are described with one embodiment or one figure, then those details can apply to similar features of components in other embodiments or other figures.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A pacifier cover comprising:
a decorative design on a front side;
a back surface opposite the front side; and
a connecting mechanism comprising:
a connector ring comprising:
an outer sidewall extending upwardly and away from the back surface;
an upper surface interconnected to the outer sidewall at an outer perimeter;
an inner surface interconnected to the upper surface at an inner perimeter; and
a curved portion with a radius of curvature interconnected to the inner surface; and
a cavity with a cavity wall extending downward from the curved portion, the cavity at least partly surrounded by the connector ring,
wherein the inner surface overhangs over the cavity and the inner surface together with the curved portion form a lip, and
wherein the lip extends inwardly from the connector ring and into the cavity.

2. The pacifier cover of claim 1, further comprising a plurality of protrusions extending upwardly from the back surface.

3. The pacifier cover of claim 1, wherein the connector ring comprises a first notch cut into the connector ring and extending downward from the upper surface of the connector ring.

4. The pacifier cover of claim 3, wherein the connector ring comprises a second notch cut into the connector ring and extending downward from the upper surface of the connector ring.

5. The pacifier cover of claim 3, wherein the notch is formed by a first sidewall, a second sidewall, and a bottom surface positioned between and connected to the first and second sidewalls, wherein the notch has a height measured from the bottom surface to the upper surface of the connector ring and a width measured from the first sidewall to the second sidewall, and wherein the height is greater than the width.

6. The pacifier cover of claim 1, wherein a material of the pacifier cover is silicone, rubber, a polymer, an elastomer, or combinations thereof.

7. The pacifier cover of claim 1, wherein the outer sidewall of the connector ring is substantially smooth and is positioned substantially perpendicular to the back surface, wherein the upper surface of the connector ring is substantially smooth and is positioned substantially perpendicular to the outer sidewall, and wherein the inner surface of the connector ring is substantially smooth and is positioned substantially parallel to the outer sidewall.

8. The pacifier cover of claim 1, wherein the lip extends around the entire connector ring.

9. The pacifier cover of claim 3, wherein the lip extends around the entire connector ring but does not extend into the first notch.

10. A method of manufacturing a pacifier cover according to claim 1.

11. A pacifier cover comprising:
a decorative design on a front side;
a back surface opposite the front side; and
a connecting mechanism comprising:
a connector ring comprising:
an outer sidewall extending upwardly from and substantially perpendicular to the back surface;
an upper surface interconnected to the outer sidewall at an outer perimeter and positioned substantially perpendicular to the outer sidewall;
an inner surface interconnected to the upper surface at an inner perimeter and positioned substantially parallel to the outer sidewall; and
a curved portion with a first radius of curvature interconnected to the inner surface; and
a cavity with a cavity wall extending downward from the curved portion, the cavity at least partly surrounded by the connector ring, and the cavity wall having a second radius of curvature;
wherein the inner surface overhangs over the cavity and the inner surface together with the curved portion form a lip,
wherein the lip extends inwardly from the connector ring and into the cavity, and wherein the pacifier cover is comprised of a bendable material.

12. The pacifier cover of claim 11, wherein the bendable material is selected from the group comprising silicone, rubber, polymers, elastomers, or combinations thereof.

13. The pacifier cover of claim 11, wherein the connector ring comprises a first notch cut into the connector ring and extending downward from the upper surface of the connector ring, wherein the notch is formed by a first sidewall, a second sidewall, and a bottom surface positioned between and connected to the first and second sidewalls.

14. The pacifier cover of claim 11, wherein the lip extends around the entire connector ring.

15. A pacifier and teether system comprising:
a pacifier having a nipple and a handle; and
a cover comprising:
a decorative design on a front side;
a back surface opposite the front side; and
a connecting mechanism having a connector ring and a cavity, the connector ring comprising:
an outer sidewall extending upwardly and away from the back surface;
an upper surface connected to the outer sidewall at an outer perimeter;
an inner surface connected to the upper surface at an inner perimeter; and
a curved portion with a radius of curvature interconnected to the inner surface and forming a lip;
wherein the cavity has a cavity wall extending downward from the curved portion, and wherein the cavity is at least partly surrounded by the connector ring,
wherein the lip extends inwardly from the connector ring and into the cavity, and
wherein a portion of the pacifier handle is positioned in the cavity such that the cover is detachably connected to the pacifier.

16. The pacifier and teether system of claim 15, wherein the cover further comprises a plurality of protrusions extending upwardly from the back surface.

17. The pacifier and teether system of claim 15, wherein the connector ring comprises a first notch cut into the connector ring and extending downward from the upper surface of the connector ring, and wherein the notch is formed by a first sidewall, a second sidewall, and a bottom surface positioned between and connected to the first and second sidewalls.

18. The pacifier and teether system of claim 15, wherein the outer sidewall of the connector ring is positioned substantially perpendicular to back surface, wherein the upper surface of the connector ring is positioned substantially perpendicular to the outer sidewall, and wherein the inner surface of the connector ring is positioned substantially parallel to the outer sidewall, and wherein the pacifier handle comprises a substantially cylindrical stem portion connected to a head portion having a diameter at a portion proximate the stem portion that is larger than a diameter of the stem portion.

19. The pacifier and teether system of claim 18, wherein the head portion of the pacifier handle is positioned in the cavity of the cover connector ring and the inner surface of the cover connector ring is positioned adjacent the pacifier stem portion when the pacifier is connected to the cover.

20. The pacifier and teether system of claim 15, wherein the cover is made of silicone, rubber, a polymer, an elastomer, or combinations thereof.
